(19) United States
(12) Patent Application Publication
(10) Pub. No.: US 2016/0277837 A1
(43) Pub. Date: Sep. 22, 2016

(54) EARPHONE AND EARPHONE SYSTEM

(71) Applicants: SHARP KABUSHIKI KAISHA, Osaka-shi (JP); TOHOKU UNIVERSITY, Sendai-shi (JP)

(72) Inventors: Junsei SATO, Osaka-shi (JP); Syuichi SAKAMOTO, Sendai-shi (JP)

(21) Appl. No.: 15/035,815

(22) PCT Filed: Nov. 6, 2014
(86) PCT No.: PCT/JP2014/079414

§ 371 Date: May 11, 2016

(30) Foreign Application Priority Data
Nov. 11, 2013 (JP) 2013-232687

(51) Int. Cl. H04R 5/033; H04R 1/28; H04S 7/00; H04R 5/04

(52) U.S. Cl. CPC H04R 5/033; H04R 5/04; H04R 1/2853; H04S 7/304; H04R 2460/07

(57) ABSTRACT

An earphone system is provided which enables a listener to listen to a localized stereophonic sound image by earphones while naturally listening to ambient sound. An earphone system (10) includes earphones (1) that are worn on ears and a signal output unit (13) that outputs a sound signal to the earphones (1). The earphone (1) includes a housing in a tubular shape whose internal space has openings at both ends or in a shape in which a portion of the tubular shape in a circumference direction is removed, a speaker unit that outputs a sound signal toward one of the openings, and a support portion that supports the speaker unit in a position which corresponds to the internal space of the tubular shape. Further, the signal output unit (11) includes a signal processing unit (13) that performs signal processing for an input sound signal to generate and output a sound signal of stereophonic sound in which a sound image is localized in a position that is assumed as an outside of a head.

### TECHNICAL FIELD

The present invention relates to an earphone system and more particularly to an earphone system that superimposes stereophonic sound from a speaker on ambient sound and enables the stereophonic sound to be listened to by an earphone.

### BACKGROUND ART

In related art, a configuration in which internal and external spaces communicate with each other through a hole has been known as means that allows a listener to listen to playback sound while a state where ambient sound may be listened to is maintained in a case where a listener listens to playback sound of sound signals by using an earphone.

For example, PTL 1 discloses an ear-canal type earphone in which a through hole for introducing ambient sound is provided to an earpiece. This allows a listener to naturally listen to ambient sound and to also listen to sound output from the earphone.

### CITATION LIST

### Patent Literature

PTL 1: Japanese Unexamined Patent Application Publication No. 2012-244350

### SUMMARY OF INVENTION

### Technical Problem

However, the earphone disclosed in PTL 1 aims to enable ambient sound to be simply listened to in a state where the listener wears the earphone and is provided on an assumption that sounds played by the earphone are music and so forth.

On the other hand, in a case of aiming to superimpose stereophonic sound on ambient sound, it is important to play accurate stereophonic sound while the impression of the sound image localization of ambient sound is maintained. However, in the configuration of the earphone of PTL 1, because the ambient sound passes through a small through hole, the frequency characteristics of the ambient sound largely change, resulting in inaccurate sound image localization. Specifically, wrong determinations of front or back about the sound image by the listener significantly increase. Here, stereophonic sound is sound in which a sound image is localized outside a head, and stereophonic sound is realized by convoluting a head-related transfer function with each of sound signals for both ears, for example.

Alternative methods may be using an open-air type headphones or earphones with microphones attached to the outsides of the earphones in order to play stereophonic sound. However, the open-air type headphones in general have a problem of a large amount of crosstalk similarly to bone conduction and are thus unsuitable for playing stereophonic sound.

Meanwhile, the earphones with microphones leads to a case where noises picked up by the microphones in general annoy the listener, and so forth. The impression of naturalness of listening is impaired by passage through the microphones. Further, because the positions of the microphones offset from the entrances of auditory meatuses of the listener, the frequency characteristics largely changes via the microphones, resulting in a significant increase in wrong determinations about the sound image localization of the ambient sound. In addition, the earphones with microphones have a problem that because the listener may not listen to the ambient sound in a case where a power source is not supplied such as a case of a dead battery, the earphones with the microphones may not be used during driving a car.

The present invention has been made in consideration of such a circumstance described above, and an object thereof is to provide an earphone system that enables a listener to listen to a localized stereophonic sound image by earphones while naturally listening to ambient sound.

### Solution to Problem

To solve above problems, first technical means of the present invention provides an earphone system including: earphones that are worn on ears; and a signal output unit that outputs a sound signal to the earphone, in which the earphone includes: a housing in a tubular shape whose internal space has openings at both ends or in a shape in which a portion of the tubular shape in a circumference direction is removed; a speaker unit that outputs a sound signal toward one of the openings; and a support portion that supports the speaker unit in a position which corresponds to the internal space of the tubular shape, and the signal output unit includes a signal processing unit that performs signal processing for an input sound signal to generate and output a sound signal of stereophonic sound in which a sound image is localized in a position that is assumed as an outside of a head.

Second technical means provides the earphone system in the first technical means, in which the housing of the earphone has an internal surface in a cylindrical shape or in a cylindrical shape whose portion in a circumferential direction is removed, and the support portion supports the speaker unit in a center position of the cylindrical shape.

Third technical means provides an earphone system including: earphones; a fixing member that fixes the earphone such that the earphone does not contact with an auricle of an ear; and a signal output unit that outputs a sound signal to the earphone, in which the earphone includes: a housing that houses a speaker unit that outputs a sound signal; and a hollow tubular portion that is mounted on the housing, and the earphone has a configuration in which a sound signal that is output from the speaker unit is emitted through an internal portion of the tubular portion and from an end of the tubular portion, and the signal output unit includes a signal processing unit that performs signal processing for an input sound signal to generate and output a sound signal of stereophonic sound in which a sound image is localized in a position that is assumed as an outside of a head.

Fourth technical means provides the earphone system in any one of the first to third technical means, in which the signal output unit includes: a signal acquisition unit that acquires a sound signal which is provided with direction information which indicates a direction of a sound with respect to a center of a head of a listener as a reference; and a head direction detection unit that detects a direction toward which the head of the listener who wears the earphone is directed by using a prescribed sensor, and the signal processing unit decides a sound source localization direction based on a direction that is detected by the head direction detection unit and the direction information that is provided to the sound signal and convolutes a head-related transfer function with a sound signal such that sound image localization is performed in the decided sound source localization direction to generate a sound signal of stereophonic sound in which the sound image localization is performed.

### Advantageous Effects of Invention

An object of the present invention is to provide an earphone system that enables a listener to listen to a localized stereophonic sound image by earphones while naturally listening to ambient sound.

### BRIEF DESCRIPTION OF DRAWINGS

FIG. 1 is a block diagram that illustrates a configuration example of an earphone system according to the present invention.

FIG. 2 is a schematic front diagram that illustrates a configuration example of an earphone that is included in the earphone system of the present invention.

FIG. 3 is a schematic side diagram of the earphone illustrated in FIG. 2.

FIG. 4 is a diagram that illustrates an internal configuration of the earphone illustrated in FIGS. 2 and 3.

FIG. 5 is a schematic front diagram that illustrates another configuration example of the earphone that is included in the earphone system according to the present invention.

FIG. 6 is a schematic front diagram that illustrates still another configuration example of the earphone that is included in the earphone system according to the present invention.

FIG. 7 is a schematic front diagram that illustrates yet another configuration example of the earphone that is included in the earphone system according to the present invention.

FIG. 8 is a schematic front diagram that illustrates yet another configuration example of the earphone that is included in the earphone system according to the present invention.

FIG. 9 is a schematic front diagram that illustrates yet another configuration example of the earphone that is included in the earphone system according to the present invention.

FIG. 10 is a schematic perspective diagram that illustrates yet another configuration example of the earphone that is included in the earphone system according to the present invention.

FIG. 11 is a schematic front diagram that illustrates yet another configuration example of the earphone that is included in the earphone system according to the present invention.

FIG. 12 is a schematic perspective diagram that illustrates yet another configuration example of the earphone that is included in the earphone system according to the present invention.

FIG. 13 is a schematic front diagram that illustrates yet another configuration example of the earphone that is included in the earphone system according to the present invention.

### DESCRIPTION OF EMBODIMENTS

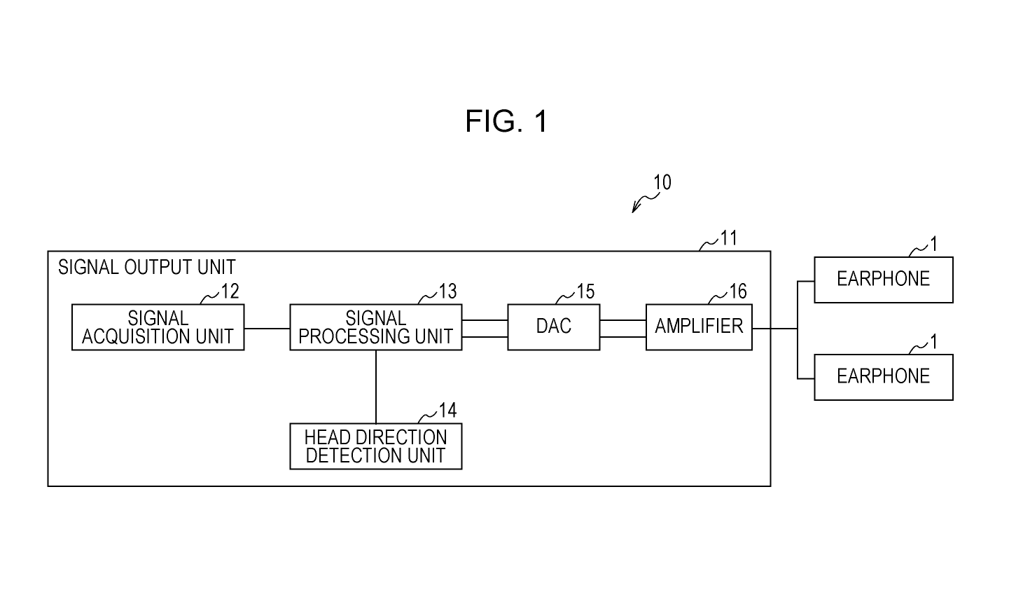

FIG. 1 is a block diagram that illustrates a configuration example of an earphone system according to the present invention. An earphone system 10 is configured with a signal output unit 11 that includes a signal acquisition unit 12, a signal processing unit 13, a head direction detection unit 14, a digital-to-analog converter (DAC) 15, and an amplifier 16 and two earphones 1.

The signal acquisition unit 12 of the signal output unit 11 acquires a sound signal with direction information via the Internet or from a local memory, for example. The direction information is information that indicates from which direction the sound is to be heard with respect to the head of a listener as the center and is expressed by the pair of two angles that are horizontal angle and elevation angle, for example. In this case, the horizontal angle and the elevation angle of the direction information may be expressed by relative angles to the head of the listener or may be expressed by absolute angles with respect to the azimuth or the vertical direction as a reference. Here, a description will be made on an assumption that the direction information is expressed by the absolute angles.

The signal acquisition unit 12 outputs the sound signal with the direction information to the signal processing unit 13. Here, a description is made while the sound signal is one channel, but two or more channels may be used. The signal processing unit 13 uses the input sound signal with the direction information to convolute a head-related transfer function with the input sound signal such that the sound image of the sound signal is localized in a direction that is decided by a method described below.

Here, as described above, in a case where the direction information is expressed by the absolute angles, the earphone system 10 detects the direction of the head of the listener by the head direction detection unit 14 in order to acquire a reference for the direction information.

Specifically, the head direction detection unit 14 uses a three-axis gyro sensor, which is built in either one of the left and right earphones 1, to detect the angle formed between the direction of the head and the reference direction and may thereby acquire a rotational angle of the direction of the head, a left-right inclination angle of the direction of the head, and a front-back inclination angle of the direction of the head with respect to the reference direction. As for the direction of the head, for example, the direction of the head of the listener is defined as an angle that is formed between the vector directed from a left ear position toward a right ear position of the listener and the reference direction in a three-dimensional space.

Alternatively, while it is assumed that the direction in which the front of the face of the listener is directed is the same as the direction of a smart phone, an electronic compass installed in a smart phone or the like is used to acquire the rotational angle, the left-right inclination angle, and the front-back inclination angle of the direction of the head based on an azimuth angle, an inclination angle, and a rotational angle that are output from a magnetic sensor of the electronic compass. The acquired angles may thereby be used. The direction of the smart phone is defined as a direction at which the angle formed between the vector, which is directed from a lower end toward an upper end of either one of left and right sides of a display surface of the smart phone as seen from the listener, and the reference direction becomes the smallest, for example.

In addition, because the absolute coordinate position of the center point of the head in the three-dimensional space is present, the head direction detection unit 14 is allowed to acquire angles with respect to six axes. The six axes represent the rotational angle of the head, the left-right inclination angle, an up-down inclination angle, an x-axis position of the center of the head, a y-axis position of the center of the head, and a z-axis position of the center of the head.

Further, only azimuth angle information of the smart phone may be used to acquire the rotational angle of the direction of the head by using not all of those angles, but focusing only on the rotational angle of the direction of the head, for example, and ignoring the front-back and left-right inclinations.

As described above, the head direction detection unit 14 outputs one or plural angles about the head to the signal processing unit 13. The signal processing unit 13 corrects the direction information input from the signal acquisition unit 12 based on the angles input from the head direction detection unit 14 and then decides a sound image localization direction. That is, the direction information that expresses from which direction the sound is to be heard by the listener is corrected such that the direction information conforms to an actually detected direction of the head of the listener, and the sound image localization direction is thereby decided. Further, as described above, the head-related transfer function is convoluted with the sound signal such that the sound image is localized in the decided sound image localization direction. Accordingly, regardless of the direction of the head of the listener, the listener hears the sound such that the sound image stays still in a specific direction. In a case where angle information about the six axes is acquired, the sound image localization may be performed such that the listener perceives that the sound image stays still in a specific position in a case where the listener walks through the side of the sound image without changing the angle of the head, for example.

Specifically, the signal processing unit 13 convolutes each of a head-related transfer function for the right ear and a head-related transfer function of the left ear with the sound signal acquired by the signal acquisition unit 12 and thereby generates two sound signals for the right ear and the left ear. The two generated sound signals are output to the DAC 15, converted into analog signals by the DAC 15, and amplified by the amplifier 16. The amplified sound signals for the right ear and the left ear are respectively output to the two earphones 1. Each of the earphones 1 outputs the input sound signal as a sound by a speaker. That is, the sound signal for the right ear and the sound signal for the left ear are respectively output from the earphone 1 for the right ear and the earphone 1 for the left ear.

In a case where the direction information is expressed by relative angles to the head of the listener, the direction information becomes information such as “horizontal angle of 90°, elevation angle of 0°”. If the horizontal angle is expressed counterclockwise, for example, in this case, the sound image is localized on just the left side of the listener. Further, at how many degrees the head is inclined from a criterion direction is regularly recognized, and the sound image may thereby be localized on just the left side of the listener when the head is directed in the reference direction.

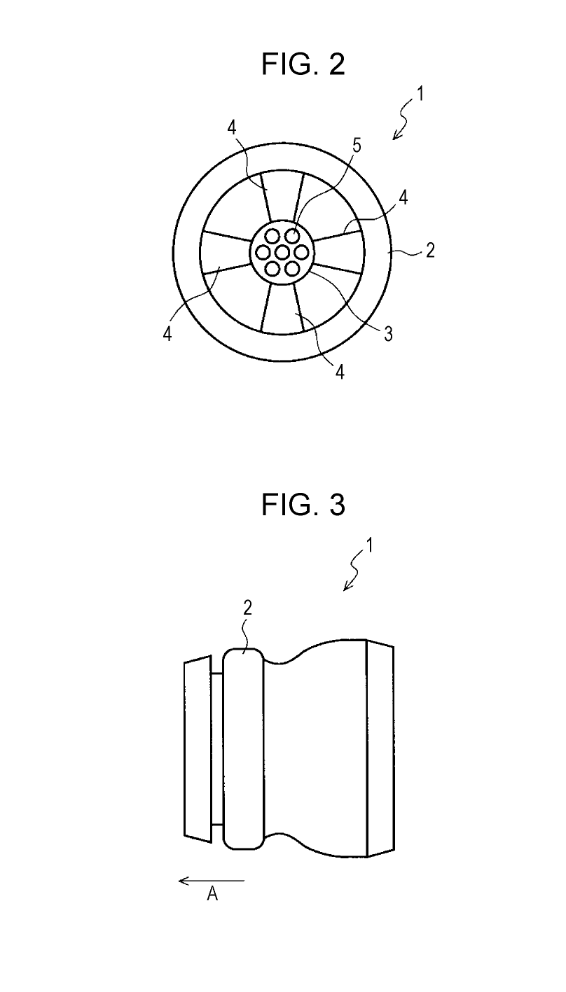

FIG. 2 is a schematic front diagram for explaining a configuration example of an earphone that is included in the earphone system of the present invention. The earphone 1 has a housing 2 to be inserted into an external auditory meatus of the listener. The housing 2 of this example has a tubular shape that has a cylindrical internal space which opens at both ends. A small-sized speaker box 3 that outputs a sound signal toward one opening is arranged at the center of the internal space. Here, although an outer periphery of the housing 2 is in a curved surface shape toward the deeper side of the page, the shape of the housing 2 in the depth direction will not be illustrated for description. The same applies to modification examples described below.

Further, in the earphone 1, a rod-shaped support portion 4 is provided between the housing 2 and the speaker box 3 in a bridge-like manner and supports the speaker box 3 in an internal portion of the housing 2. In this example, four rod-shaped support portions 4 are provided. However, the number or shape of the support portion 4 is not limited. Further, a speaker driving unit (not illustrated) that includes a diaphragm is housed in an internal portion of the speaker box 3, and plural holes 5 that allow a sound output from the diaphragm to pass are provided in a wall portion of the speaker box 3 on the auditory meatus side. The speaker box 3 corresponds to a speaker unit of the present invention.

FIG. 3 is a schematic side diagram of the earphone illustrated in FIG. 2. The earphone 1 is worn on the ear of a user toward the arrow A direction in the drawing. In this case, an external surface shape of the earphone 1 is preferably a shape that fits an entrance of the external auditory meatus of the user with no gap.

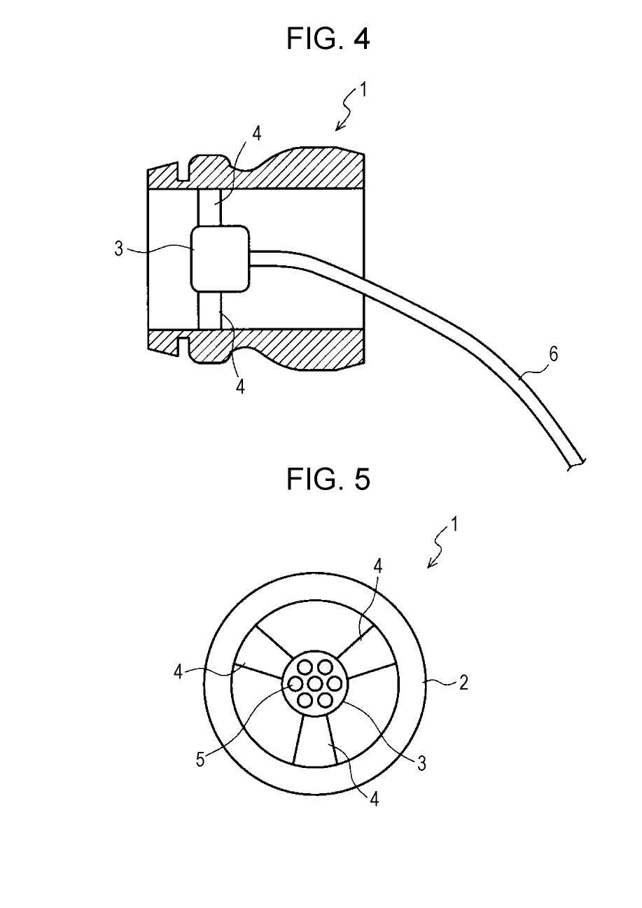

FIG. 4 is a diagram that illustrates an internal configuration of the earphone illustrated in FIGS. 2 and 3. A cable 6 that inputs the sound signal is connected with the speaker box 3 at a central portion of the earphone 1 and is guided to the outside of the housing 2 through the internal space of the cylindrical shape of the housing 2. The cable 6 guided out from the earphone 1 is connected with the amplifier 16 of the signal output unit 11 illustrated in FIG. 1, and the sound signal output from the amplifier 16 is output from the speaker box 3 as a sound.

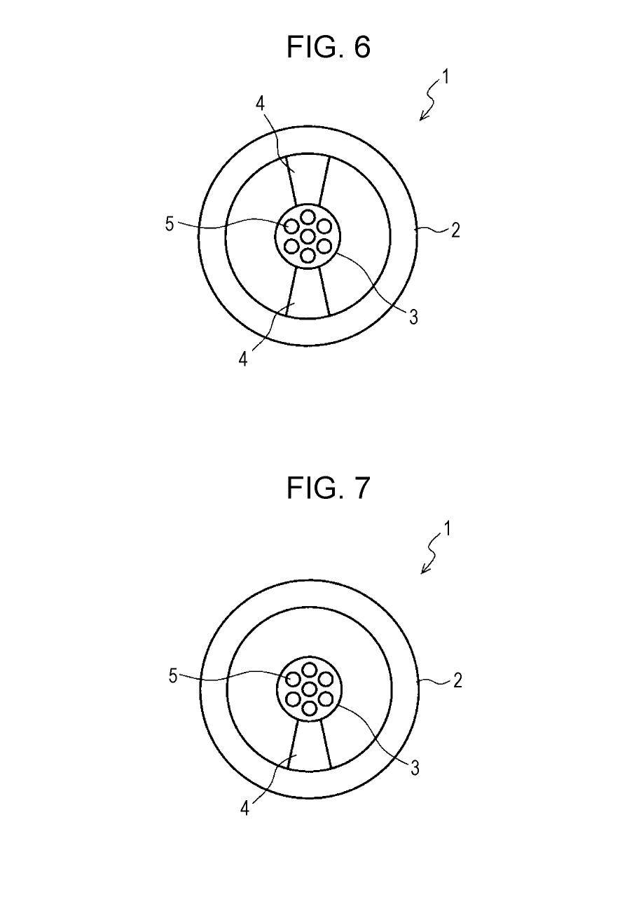

FIGS. 5 to 9 are schematic front diagrams for explaining other configuration examples of the earphone that is included in the earphone system according to the present invention and respectively illustrate examples where the numbers of the support portions 4 provided in the housing 2 of the earphone 1 are different. In an example of FIG. 5, the speaker box 3 in the internal portion of the housing 2 is supported by three rod-shaped support portion 4. Further, in an example of FIG. 6, the number of the rod-shaped support portions 4 is set to two. Further, in an example of FIG. 7, the speaker box 3 is supported by one support portion 4.

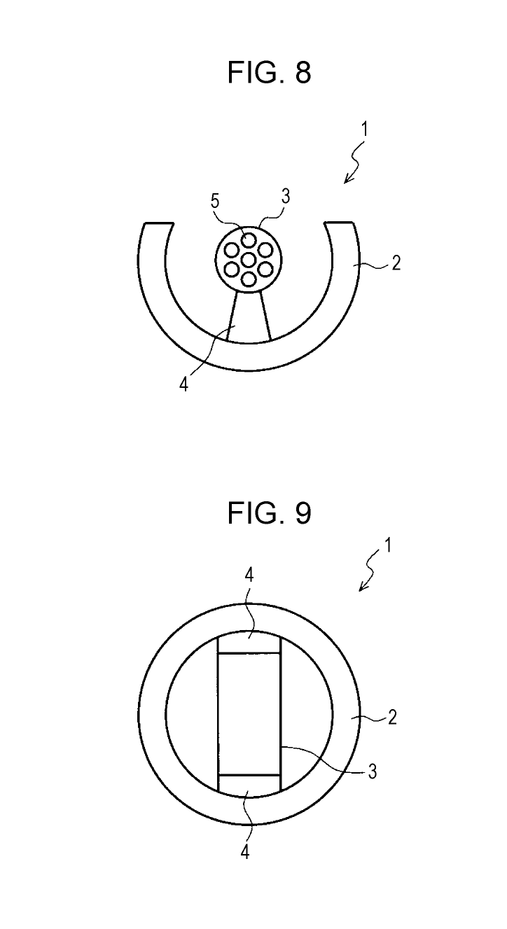

Further, in an example of FIG. 8, the wall portion of the housing 2 that is formed in a tubular shape is configured to be partially removed in the circumferential direction of the tubular shape. Accordingly, a cross section of the housing 2 in a case where the earphone 1 is seen from the front (from the front in a sound emitting direction of the speaker) is in a circular arc shape. The speaker box 3 is supported in the position that corresponds to the cylindrical internal space whose portion in the circumferential direction is removed.

Further, in an example of FIG. 9, the speaker box 3 is configured into an oblong rectangular shape, and the speaker box 3 is supported by two support portions 4. A configuration of FIG. 9 may be applied to an earphone that uses a speaker box which includes a speaker in a rectangular shape.

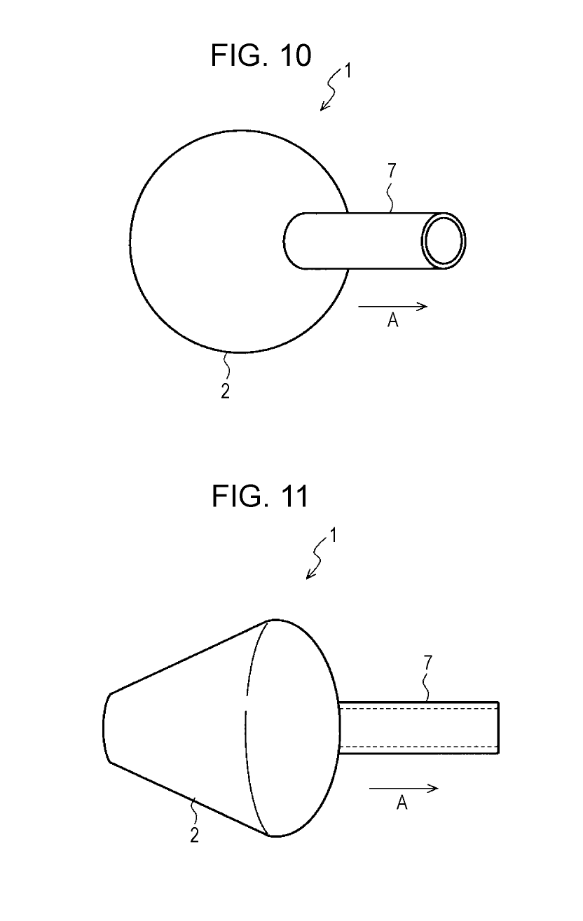

FIGS. 10 to 13 are schematic perspective diagrams or schematic side diagrams for explaining still other configuration examples of the earphone that is included in the earphone system according to the present invention.

The earphone 1 of a configuration example of FIG. 10 includes the housing 2 that houses a speaker box and a hollow tube 7 (which corresponds to a tubular portion of the present invention) that is mounted on the housing 2. An internal space of the tube 7 communicates with a front space of the speaker box. Further, the housing 2 is fixed to a space adjacent to the entrance of the external auditory meatus such that the housing 2 does not contact with an auricle of the listener. An end of the tube 7 mounted on the housing 2 is inserted in an internal portion of the external auditory meatus such that the end of the tube 7 does not contact with a wall surface of the external auditory meatus. The inserting direction is the direction indicated by the arrow A.

The housing 2 is fixed to a vicinity of the entrance of the external auditory meatus of the listener by using a fixing member such as a head band or a neck band, for example, or a fixing member that locks the housing 2 on the auricle of the listener. The sound signal output from the speaker box is output through the internal portion and from the end of the tube 7, and the listener may thus listen to stereophonic sound, in which the sound image is localized, by the earphones 1 in a state where the listener may hear ambient sound.

FIG. 11 illustrates an example in a similar configuration to FIG. 10, and the earphone 1 includes the housing 2 that is fixed to a vicinity of the entrance of the external auditory meatus of the listener and the tube 7 that outputs playback sound of the speaker box of the housing 2. The difference from FIG. 10 is the shape of the housing 2, which is a shape in which an outer periphery of the housing is tapered toward the opposite side from the inserting direction. The example of FIG. 11 has a similar configuration to FIG. 10 except this shape.

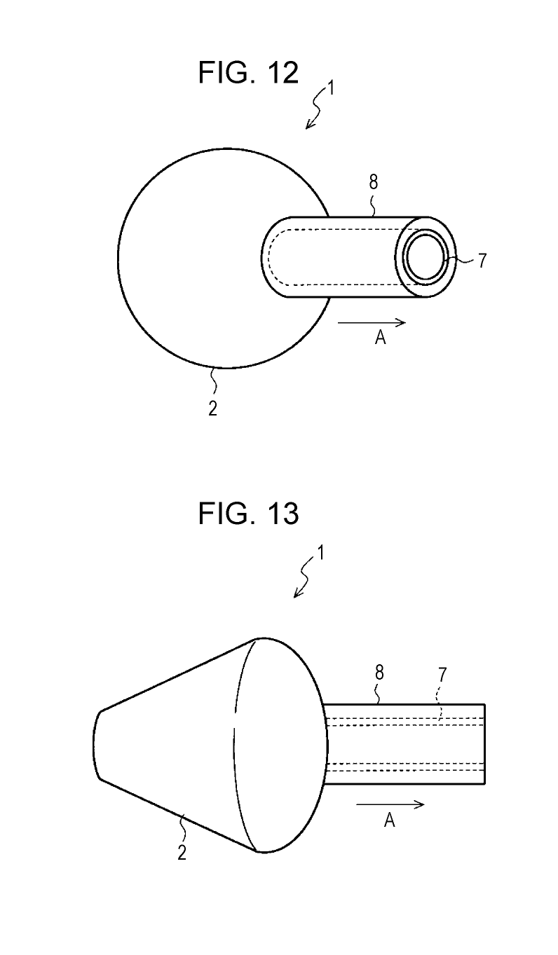

The examples of FIGS. 12 and 13 have similar configurations to the earphones 1 in the respective configurations of FIGS. 10 and 11 and illustrate the earphone 1 in which a support member 8 that allows a sound to pass is further provided around the tube 7. A flexible porous material such as a sponge, for example, may be used for the support member 8. Further, the support member 8 is allowed to contact with the wall surface of the external auditory meatus of the listener, and the tube 7 is thereby supported and stabilized in the internal portion of the external auditory meatus. The support member 8 that allows a sound to pass is used, and the listener may thereby listen to stereophonic sound, in which the sound image is localized, by the earphones 1 in a state where the listener may hear the ambient sound.

In the above embodiments according to the present invention, the earphone 1 has a structure in which the speaker box 3 that is provided at the center of the housing 2 in the tubular shape whose internal space opens at both of the ends or in the shape in which a portion of the tubular shape in the circumference direction is removed is supported by the support portion 4. Alternatively, the earphone 1 includes the housing 2 that is fixed not to contact with the auricle of the listener and the tube 7 that emits the sound signal, which is output from the speaker box housed in the internal portion of the housing, from the end. In this configuration, an external space of the earphone 1 communicates with a space on the auditory meatus side of the listener, and a structure is thus formed in which the ambient sound enters the ears of the listener without being damped. Accordingly, the listener may naturally hear the ambient sound and may listen to stereophonic sound in which the sound image is localized, in such a state.

Here, in a case where the space in the housing 2 that allows a space on the external auditory meatus side to communicate with the external space is small, because the ambient sound enters the ears of the listener while being damped and noises from the inside of body such as the sound of blood flow and respiratory sounds are further heard similarly to a case of using earplugs, naturalness is impaired. Further, in a case where a space that allows the space on the external auditory meatus side to communicate with the external space is small, a so-called masking phenomenon, in which the sound output from the speaker of the earphone 1 drowns out the ambient sound, is likely to occur. The earphones of the embodiments according to the present invention may solve such problems.

Further, in a case of using the earphone system according to the present invention, a stereophonic sound image may be localized while the listener naturally listens to the ambient sound. Accordingly, for example, the present invention may be applied to an application that allows the listener to listen to a sound which guides the listener toward a certain azimuth. This enables the listener to listen to the sound that guides the listener in a certain direction while the listener is allowed to naturally listen to the ambient sound but does not experience stress or the like.

Alternatively, the earphone system according to the present invention may be applied to an application for so-called augmented reality, which realizes a world with new senses by superimposing stereophonic sound on ambient sound. Specifically, there is an application for a cellular phone or the like, in which a voice of the other person is localized outside the head in a case of speaking with a person who is present in a remote place and conversation may thereby be performed as if the other person were present in just the front. Alternatively, it is possible to realize augmented reality for visual and auditory perceptions by using the earphones for a head-mounted display.

### REFERENCE SIGNS LIST

1 earphone

2 housing

3 speaker box

4 support portion

5 hole

6 cable

7 tube

8 support member

10 earphone system

11 signal output unit

12 signal acquisition unit

13 signal processing unit

14 head direction detection unit

15 DAC

16 amplifier

1-4. (canceled)

5. An earphone comprising:
a housing in a tubular shape whose internal space has openings at both ends or in a shape in which a portion of the tubular shape in a circumference direction is removed;
a speaker unit that outputs a sound signal toward one of the openings; and
a support portion that supports the speaker unit in a position which corresponds to the internal space of the tubular shape.

6. An earphone system comprising:
the earphone according to claim 5; and
a signal output unit that outputs a sound signal to the earphone, wherein
the signal output unit includes a signal processing unit that performs signal processing for an input sound signal to generate and output a sound signal of stereophonic sound in which a sound image is localized in a position that is assumed as an outside of a head.

7. The earphone system according to claim 6, wherein
the housing of the earphone has an internal surface in a cylindrical shape or in a cylindrical shape whose portion in a circumferential direction is removed, and the support portion supports the speaker unit in a center position of the cylindrical shape.

8. The earphone system according to claim 6, wherein
the signal output unit includes a signal acquisition unit that acquires a sound signal which is provided with direction information which indicates a direction of a sound with respect to a center of a head of a listener as a reference, and a head direction detection unit that detects a direction of the head of the listener who wears the earphone by using a prescribed sensor, and
the signal processing unit decides a sound source localization direction based on a direction that is detected by the head direction detection unit and the direction information that is provided to the sound signal and generates a sound signal of stereophonic sound such that sound image localization is performed in the decided sound source localization direction.

9. An earphone comprising:
a housing that houses a speaker unit that outputs a sound signal; and
a hollow tubular portion that is mounted on the housing and is so thick as not to contact with a wall surface of an external auditory meatus, wherein
the earphone has a configuration in which a sound signal that is output from the speaker unit is emitted through an internal portion of the tubular portion and from an end of the tubular portion.

10. An earphone system comprising:
the earphone according to claim 9;
a fixing portion that fixes the tubular portion of the earphone such that the tubular portion does not contact with the wall surface of the external auditory meatus; and
a signal output unit that outputs a sound signal to the earphone, wherein
the signal output unit includes a signal processing unit that performs signal processing for an input sound signal to generate and output a sound signal of stereophonic sound in which a sound image is localized in a position that is assumed as an outside of a head.

11. The earphone system according to claim 10, wherein
the signal output unit includes a signal acquisition unit that acquires a sound signal which is provided with direction information which indicates a direction of a sound with respect to a center of a head of a listener as a reference, and a head direction detection unit that detects a direction of the head of the listener who wears the earphone by using a prescribed sensor, and
the signal processing unit decides a sound source localization direction based on a direction that is detected by the head direction detection unit and the direction information that is provided to the sound signal generates a sound signal of stereophonic sound such that sound image localization is performed in the decided sound source localization direction.

12. An earphone comprising:
a housing that houses a speaker unit that outputs a sound signal;
a hollow tubular portion that is mounted on the housing and is so thick as not to contact with a wall surface of an external auditory meatus; and
a support portion that contacts with the wall surface of the external auditory meatus to support the earphone, wherein
the earphone has a configuration in which the sound signal that is output from the speaker unit is emitted through an internal portion of the tubular portion and from an end of the tubular portion, and
the support portion is configured with a porous material that transmits sound.

13. An earphone system comprising:
the earphone according to claim 12; and
a signal output unit that outputs a sound signal to the earphone, wherein
the signal output unit includes a signal processing unit that performs signal processing for an input sound signal to generate and output a sound signal of stereophonic sound in which a sound image is localized in a position that is assumed as an outside of a head.

14. The earphone system according to claim 12, wherein
the signal output unit includes a signal acquisition unit that acquires a sound signal which is provided with direction information which indicates a direction of a sound with respect to a center of a head of a listener as a reference, and a head direction detection unit that detects a direction of the head of the listener who wears the earphone by using a prescribed sensor, and
the signal processing unit decides a sound source localization direction based on a direction that is detected by the head direction detection unit and the direction information that is provided to the sound signal and generates a sound signal of stereophonic sound such that sound image localization is performed in the decided sound source localization direction.
